(19) United States
(12) Patent Application Publication
(10) Pub. No.: US 2010/0288895 A1
(43) Pub. Date: Nov. 18, 2010

(54) Universal holder and flexible member for mounting, holding, and adjustably positioning electronic products and accessories

(76) Inventor: Steven Shamie, Brooklyn, NY (US)

Correspondence Address: EZRA SUTTON & ASSOCIATES, P.A., SUITE 201, 900 ROUTE 9 NORTH, WOODBRIDGE, NJ, 07095, US

(21) Appl. No.: 12/661,571

(22) Filed: Mar. 19, 2010

Related U.S. Application Data
(63) Continuation-in-part of application No. 12/454,138, filed on May 13, 2009, now abandoned.

(51) Int. Cl. F16M 13/02

(52) U.S. Cl. 248/222.14

(57) ABSTRACT

In the first embodiment, a universal flexible connector or gooseneck and a movable holding device are provided for adjustably positioning electronic accessories relative to a TV or furniture. A mounting lug is connected to the flexible connector for mounting electronic accessories relative to a TV frame, wherein the TV frame is for mounting a TV on a wall. The holding device has adjustable arms for receiving any electronic component or accessory or media playing device (MPD), wherein said holding device is removably connected to the other end of the flexible connector. The flexible connector and holding device for holding the electronic component or accessory or media playing device (MPD) are movable as a unit to different positions relative to a TV, outside the periphery of the TV, for easy access to the electronic component or accessory by the user.

### RELATED CASES

This application is a continuation in part of application Ser. No. 12/454,138 filed on May 26, 2009.

### FIELD OF THE INVENTION

An easy to install and use universal holder and flexible member are provided which, when mounted, is placed adjacent to a TV, computer screen, or furniture. It allows the user to mount, hold, and/or connect any electronic product or accessory to a TV or computer to play audio, view videos and photos, and play games on the TV or computer screen.

### BACKGROUND OF THE INVENTION

Many electronic products exist that can be connected to a TV. However, they all require an adjacent shelf or a piece of furniture to rest on.

To replace this requirement, an object of the present invention is to mount a universal holder and flexible gooseneck behind the TV or computer screen. Once in place, it will securely hold and/or provide for the connecting of all electronic devices, such as media playing devices, digital cameras, video cameras, and all other electronic consoles and components, including accessories, such as remote controls.

An alternate use of this product is to mount it to furniture for the same use for computer screens and as a convenient holder when mounted to furniture alone.

Some Products may exist for mounting and connecting certain electronic products, such as cable boxes to a TV. However, these products are always fixed in one place. They are not movable from one position to another. Also, they are not adjustable to accommodate different sizes of electronic products. Nor are they quickly and easily detachable so that they cannot be seen while not in use.

Use of three very versatile components makes usage of the present invention universal: the mounting lug, the flexible gooseneck member, and the universal holder. For example, the mounting lug can be mounted to any flat surface which makes the invention useable in a variety of places. If one wants to connect any electronic product to a TV, he may choose to bolt the lug of the present invention directly to the TV wall bracket or screw it directly into the wall behind the TV. If one wants to connect or hold one of the electronic product adjacent to a computer, it can be easily bolted or screwed into any piece of furniture such as a desk. And, it also can be screwed into a nightstand to conveniently hold a TV remote, PDA, or cell phone. This would aid in the prevention of remote controls from being lost or misplaced. And since a device such as a remote control or PDA can be placed in the holder of the present invention, it no longer needs to be placed on the surface of the night table. This aids in the reduction of clutter and adds more usable space. In addition, this makes viewing and charging the device easier. Further, one no longer needs to pick up the cell phone to see who is calling. Now when a phone call comes in, a glance replaces the need to actually pick up the phone by hand to see who the caller is.

Moreover, since the present invention utilizes a flexible gooseneck member and a universal holder, it is an object of the present invention that any electronic product can be mounted, held, adjustably positioned, accesses and utilized anywhere around the periphery of the TV. Electronic products such as: a cable box, satellite receiver, DVD/Blue ray player, Apple TV, Roku, and all other electronic components, gaming consoles such as Xbox, Play station, and Wii, laptop computers, cell phones, PDA's like Blackberry and iPhone, digital cameras, video cameras, and consoles not mentioned herein, can be securely mounted & adjustably positioned, accessed and utilized anywhere around the periphery of a TV. For example, one may choose to use the invention to mount, hold and connect his DVD player on top of the TV screen. Also, one may choose to mount, hold and connect his gaming console below the TV. Another example may be utilizing the present invention to mount, hold, and connect a media playing device to the left or right side of the TV.

It may be further noted that it is an object of the present invention that the holder for receiving the electronic product is detachable from the flexible gooseneck so that it will not be in sight when it is not in use.

### SUMMARY OF THE INVENTION

A flexible gooseneck member and an adjustable holding device are provided for adjustably positioning electronic products and accessories relative to a TV, computer screen, or furniture which includes:

a) A mounting lug for mounting the present invention behind a TV or computer screen, to furniture or anywhere else one desires.

b) The flexible member or gooseneck is connected at one end to the mounting lug;

c) A holding device having adjustable ratcheting & gripping arms for receiving and securing electronic products or accessories, which is removeably connected to the other end of the flexible gooseneck member; and

d) The flexible gooseneck member and said holding device for holding the electronic product or accessory are mountable and moveable as a unit to different positions around the periphery of the TV or computer screen for easy access by the user.

### BRIEF DESCRIPTION OF DRAWINGS

Further objects, features and advantages of the present invention will become apparent upon the consideration of the following detailed description of the presently preferred embodiment when taken in conjunction with the accompanying drawings, wherein:

FIG. 1 shows the rear view of a TV 10 and a TV frame 12, and different types of electronic products and accessories connected to the frame 12, including a media playing device (MPD) 16 supported in a holder 14, a remote control unit 18 supported in a holder 20, and a cable box 30 supported in a holder 32, and other accessories, including cradle holder 40 and video camera 50;

FIG. 1A shows the front view of the TV 10 with the various electronic products and accessories 16, 18, and 30 connected to it;

FIG. 2A shows the details of the holding unit 32 for a component and console holder 30, and the gooseneck 100 with a lug 120 at the end of the gooseneck;

FIG. 2B shows the rear view and Velcro for wire management;

FIG. 3A shows a front top view of holder unit 32 having gripper arms 34 for holding a cable box 30, and FIG. 3B shows a front bottom view of the gripper arms 34 that can be moved vertically and horizontally, and for holding and storing remote controls and miscellaneous items on the bottom surface;

FIG. 4A shows the cradle holder 14 having gripper arms 18 for holding a media playing device cradle, and FIG. 4B shows that the gripper arms can be moved vertically and horizontally.

FIG. 5 shows details of the holder 14 and the gripper arms 18 being adjustable to receive any media playing device (MPD), any small digital camera, or any PDA/cell phone holder;

FIG. 6 shows a holding device 40 having movable side arms 42 for adjustment for receiving an electronic device or accessory such as a video camera or SLR camera 44;

FIG. 7 shows an additional mount option of a component or console holder 32, to a wall;

FIG. 8 shows an adjustable holder 60 connected to a gooseneck mounted on a desk, for connecting it to a computer;

FIG. 9 shows an adjustable holder 60 connected to a gooseneck mounted on a cabinet or night stand so it is visible without having to pick it up; and

FIGS. 10A and 10B show the details of the lug 120 connected to the end of the flexible connector 100 or gooseneck.

### DETAILED DESCRIPTION OF FIRST EMBODIMENT

The present invention is directed to and consists of various electronic product holders universally designed to hold electronic items of various shapes and sizes. They all serve the purpose of allowing the user to securely mount, hold, adjustably position, access and utilize any electronic product relative to a TV, computer and home and office furniture. They replace the need for there to be a piece of furniture or a shelf near the TV for the electronic product to rest so it be connected. The present invention includes but is not limited to the 5 holders described below.

For the primary purpose of allowing the user to connect any small electronic product to the TV (to hear its audio, view its video, and see its photos), the Universal Small Device Holder (USDH) has been designed to accommodate any small pocket sized electronic product. This includes but is not limited to items such as any media playing device, small digital camera, personal digital assistant, and cell phone. This product may also be used next to a computer or adjacent to a bed or sofa as a convenient holder.

For the primary purposes of saving space and of providing a reliable place to keep remote controls in plain sight, so they do not get misplaced, the handy Universal Remote Control Holder (URCH) has been designed to hold any remote control. It can be placed anywhere around the periphery of the TV, or on a piece of furniture next to a bed or sofa.

For the purpose of allowing the user to connect an electronic product to a TV so that the audio can be heard, videos can be viewed, and photos can be seen on the TV screen, the Universal Component & Console Holder (UCCH) has been designed to accommodate any type of component such as a cable box, satellite receiver, DVD/Blueray, any stereo components, gaming systems, laptops, video storage, and playing devices, etc. This product offers the user a simple, convenient and economical solution for mounting and connecting these products to a TV where there is no furniture or shelf near the TV.

The Universal Camera Holder (UCH) allows the user to connect a video camera or single lens reflex camera to a TV so that the user can view its video and photos and listen to its audio through the TV. The Universal Cradle Holder (UCRH) accommodates any device that comes with its own cradle.

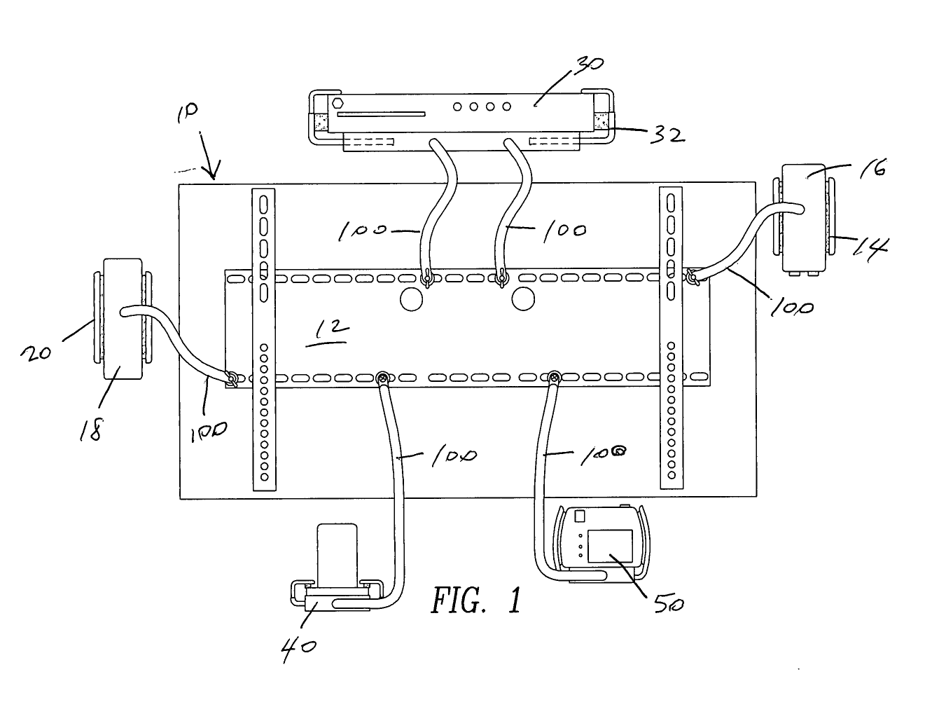

FIG. 1 shows the rear view of a TV 10 and a TV wall bracket 12, and various types of electronic products and accessories being held in the holders of the present invention and bolted to the TV wall bracket 12, including a media playing device (MPD) 16 supported in the holder 14, a remote control unit 18 supported in the holder 20 of the present invention, and a console or component such as a cable box 30, supported in the holder 32 of the present invention, and other electronic products and accessories, such as a cradle 40, and video camera 50. The holders are connected to flexible connectors or goosenecks 100, which are bendable and movable to adjustably position the holders. In this manner, the user can use his own wiring to connect them to his TV or computer.

FIG. 1A shows the front view of the TV 10, with the various electronic products and accessories being held in the present invention mounted behind the TV screen & adjustably positioned around the periphery of the TV or computer screen.

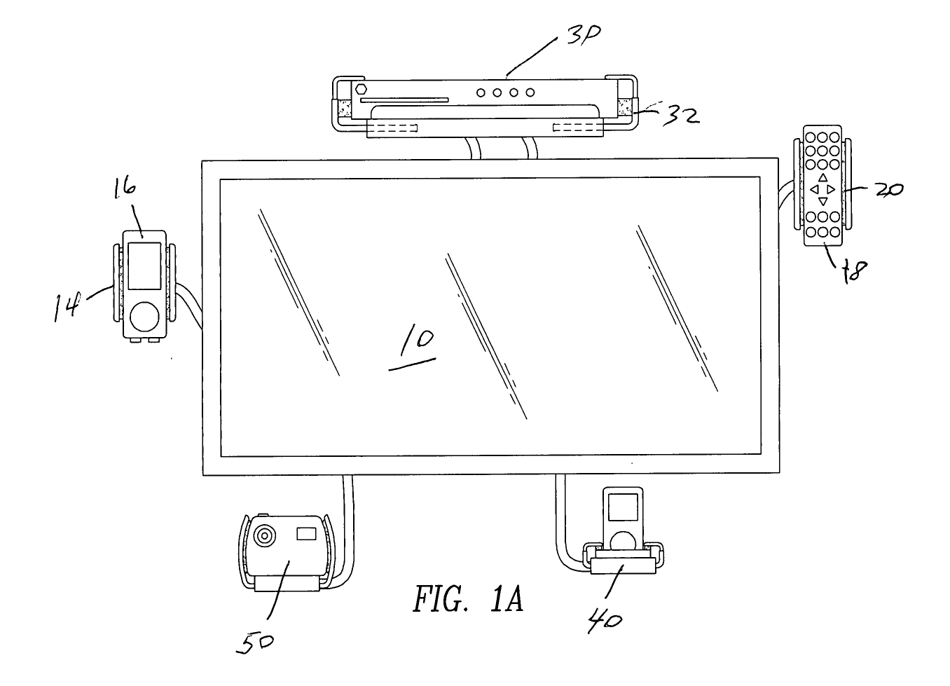

FIG. 2A shows the details of the holding unit 32, for holding components and consoles 30, and the goosenecks 100, with mounting lugs 120, at the end of the goosenecks. The holding unit 32 has adjustable arms 34 and 36 on each end of unit 32.

FIG. 2B shows the rear view of the gooseneck 100 and the Velcro used for wire and cable management.

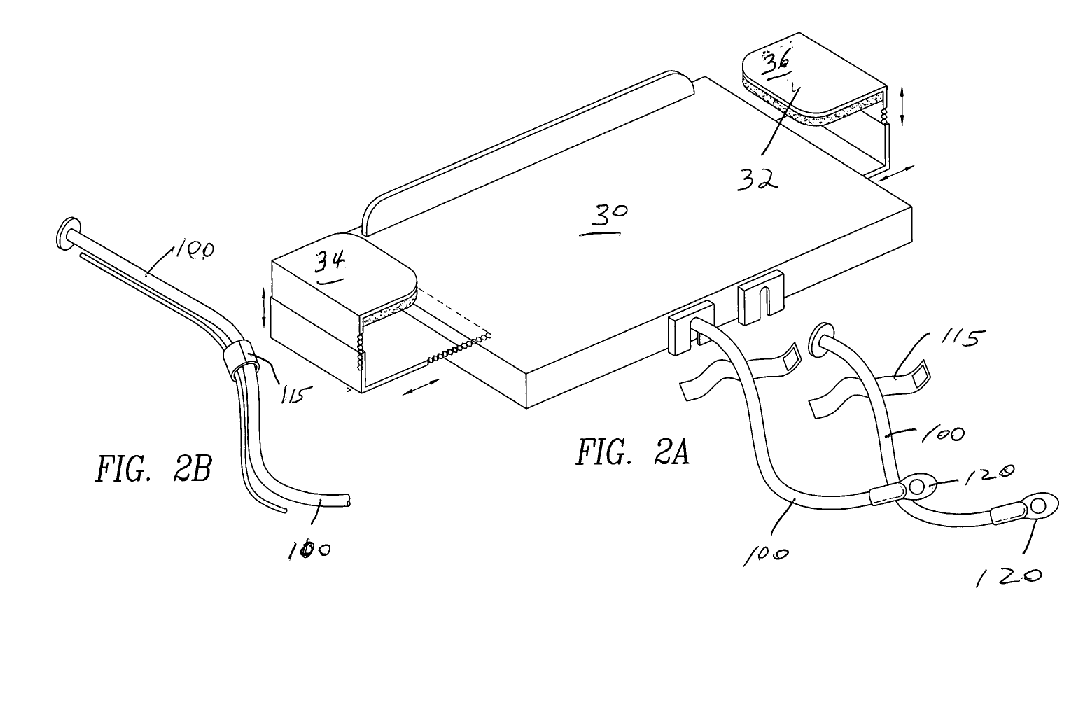

FIG. 3A shows a front top view of the holder 32 of the present invention, having ratcheting gripper arms 34 and 36, that move vertically and horizontally for universally holding an electronic console or component, such as a cable box 30.

FIG. 3B shows the front bottom view of the holder 32, which provides for the holding and storage of remotes 18, product transformers, and miscellaneous items 16 on the bottom surface.

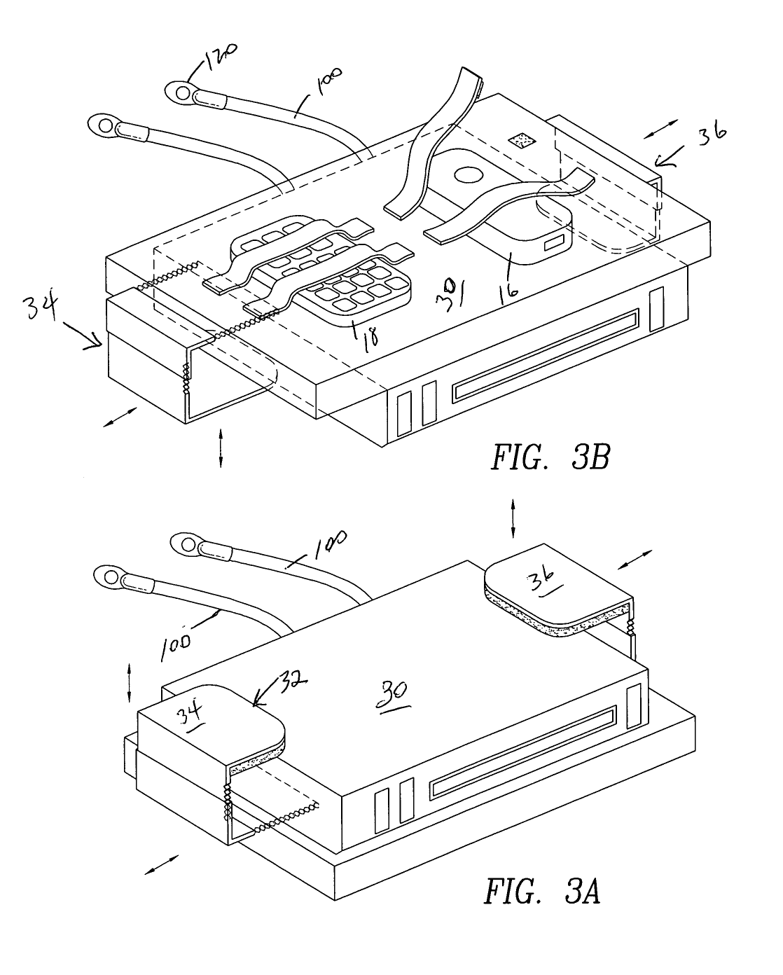

FIG. 4A shows the cradle holder 40 of the present invention, having gripping arms 42 and 44, for holding a media playing device or any other electronic product that has its own cradle.

FIG. 4B shows that the ratcheting gripper arms 42 and 44 can be moved vertically & horizontally.

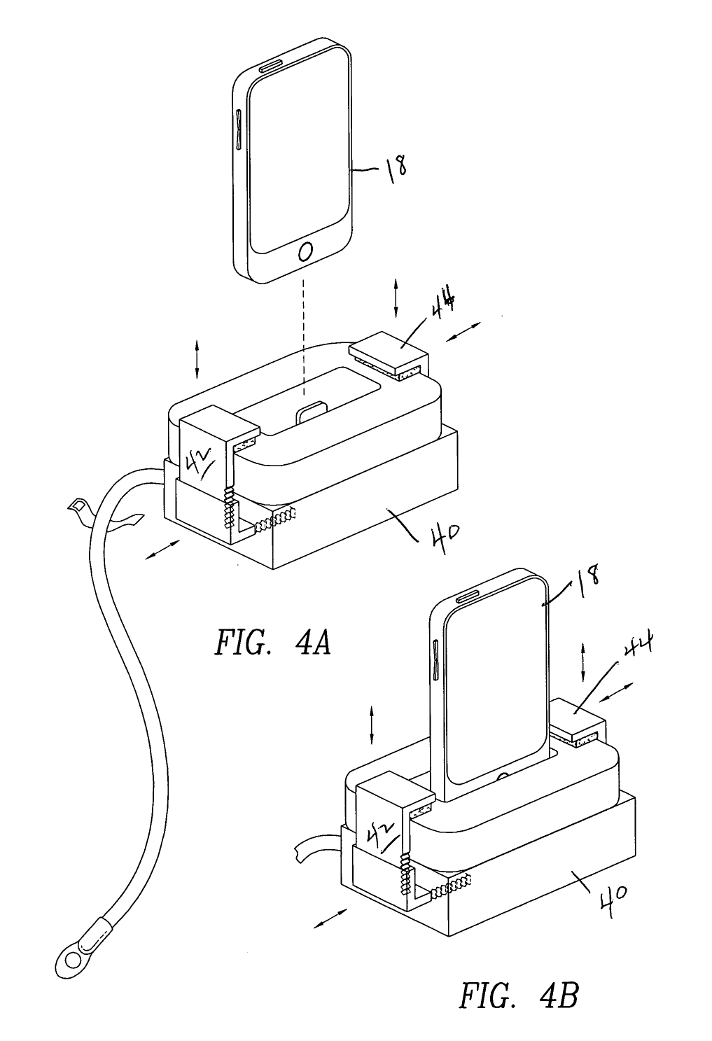

FIG. 5 shows details of the universal media playing device, small camera, PDA, and cell phone holder 50 of the present invention, and the gripper arms 52 and 54, being adjustable to receive the various devices. It also shows that this product has been universally designed to accommodate almost any device no matter where its plug receptor is. This is because it has cut outs 56 in the gripper arms to aid in the easy plugging in of wires into the device.

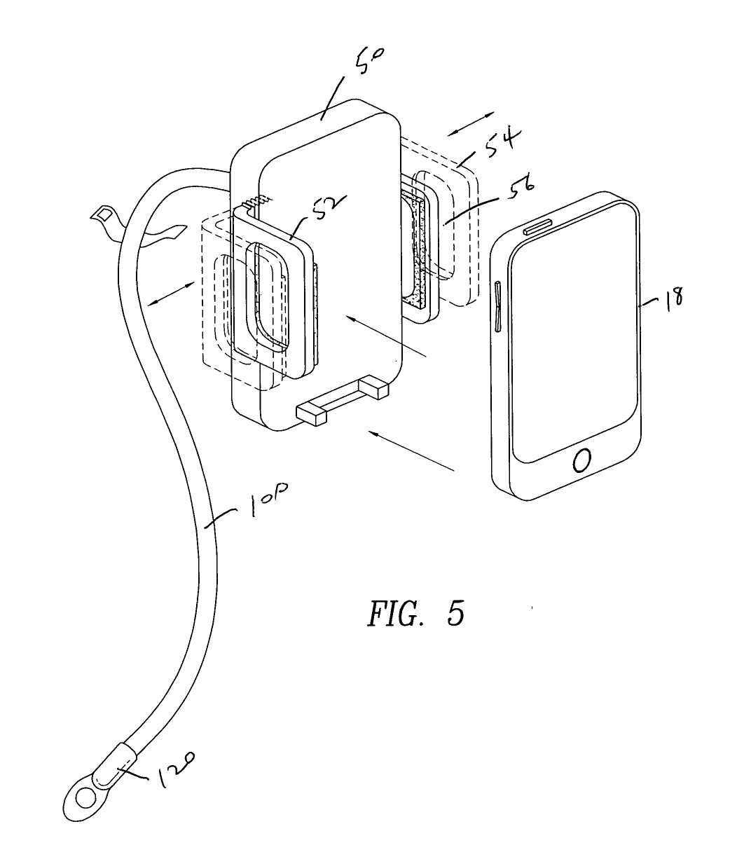

FIG. 6 shows a holding device 60 of the present invention having moveable, ratcheting, and adjustable side arms 62 and 64, for holding devices like video cameras and SLR cameras 66 on a base 68. It too has cutouts in the side arms to aid in the easy plug in of wires.

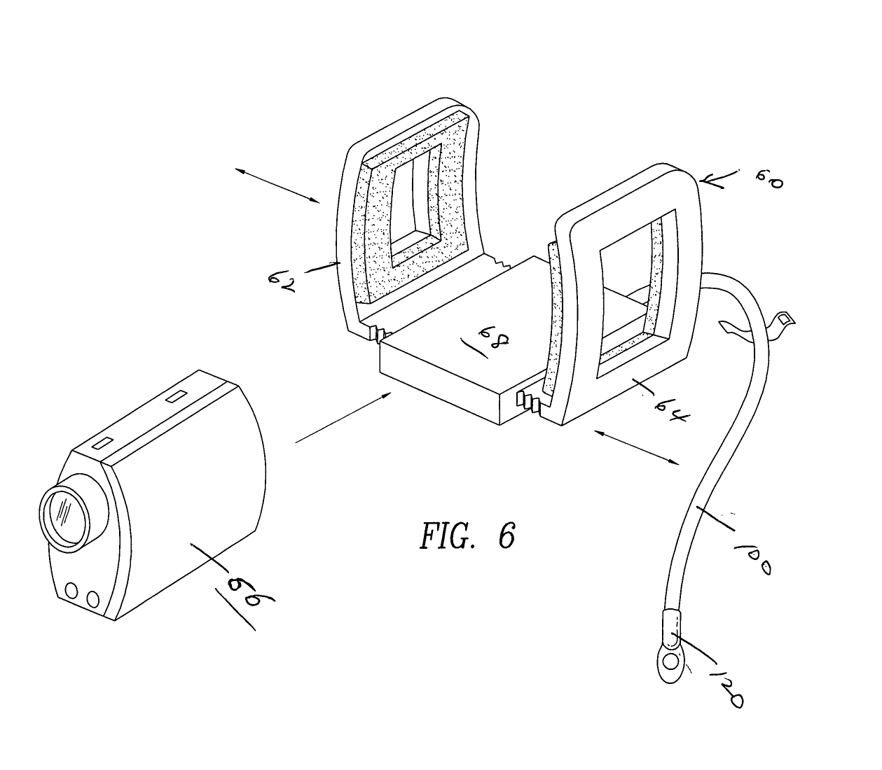

FIG. 7 shows an additional mount option of a component or console holder 32, to a wall 130 and not to the TV wall bracket itself.

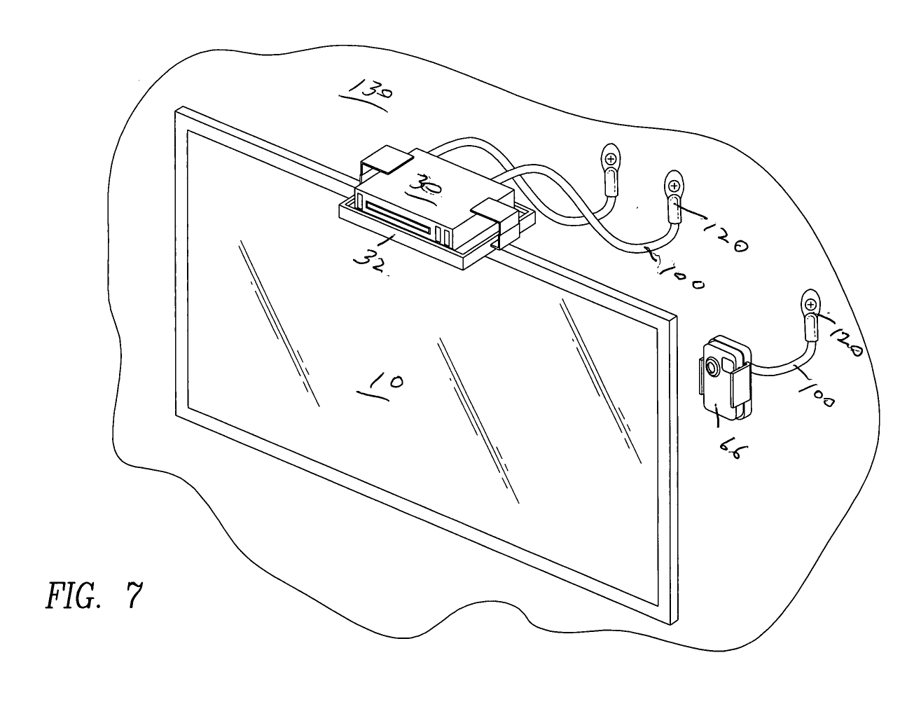

FIG. 8 shows an adjustable holder 70, connected to a gooseneck 100 mounted on a desk 72 for connecting it to a computer 74 or to hold in the user's sight for easy viewing & usage.

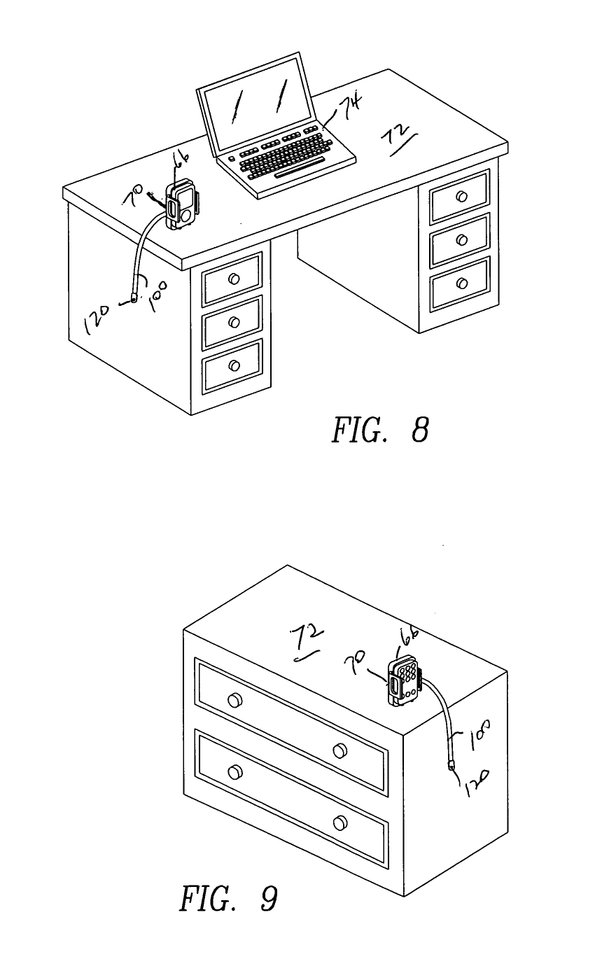

FIG. 9 shows the universal remote control holder 70 of the present invention, connected to a gooseneck 100 mounted on a cabinet or night stand 72. When kept In this position it is unlikely that it will become lost or misplaced.

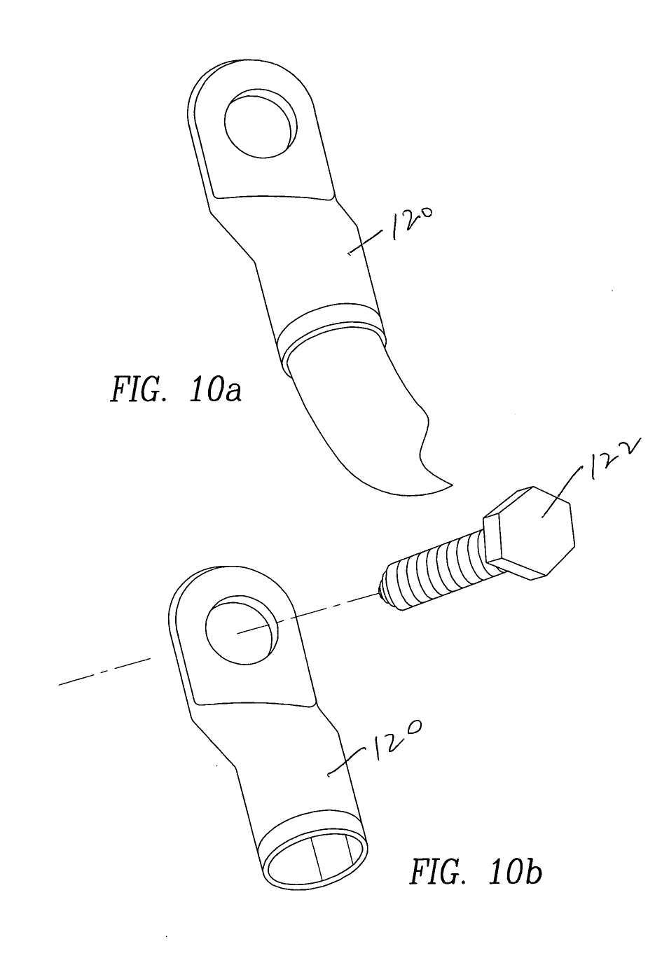

FIGS. 10A and 10B show the details of single bolt mounting lug 120, connected to the end of the flexible gooseneck member 100 for receiving a bolt 122.

The flexible or bendable connector 100 is made out of any flexible material that can give the product flexibility and the ability to move back, forth, up, down, left, and right relative to a TV or piece of furniture. Alternatively, where there is sufficient space behind the TV, the holders and/or accessories can be bent and moved behind the TV so that they are not visible. Also, the holder can be disconnected from the end of the gooseneck 100, and then the gooseneck without the holder can be moved behind the TV so the goosenecks are not visible.

The flexible connector 100 is constructed out of flexible metal, metal coil, rubber, plastic, or any combination of these materials, or any other flexible material. For example, it may be a plastic covered metal flexible connector 100, or a rubber covered metal coil flexible connector 100. The flexible connector 100 may also be referred to as a goose neck member.

An appropriate lug 120 is provided to mount flexible connector 100 on the TV frame 12 behind the TV which is supporting the TV. This can be any mounting device, such as a lug 120, for securing the flexible connector 100 to the TV frame 12 behind the TV or directly to the wall.

In this manner, the flexible connector or gooseneck 100 and the electronic components and holders can be moved to different positions relative to the TV, so that the user has access to the component or accessory.

It should be understood that flexible connector 100 is deformable so that it maintains whatever position the user bends it into.

### FURTHER INVENTION DETAILS

1) It should be understood that the flexible member or gooseneck 100 is deformable so that it maintains whatever position the user bends it into. Also, it can be constructed out of flexible metal, metal coil, rubber or any combination of these materials or any other flexible material not mentioned herein. For example, plastic covered metal or a rubber covered metal coil.

2) Another version of the mounting lug may have 2 or more holes at its base to accommodate multiple lag bolts or screws for heavy duty applications.

3) The holding device may be made out of metal, plastic or any combination of these materials.

4) Depending on the weight of the product being held, multiple goosenecks 100 may be utilized for additional support.

### INVENTION ADVANTAGES

1) Eliminates the need to have furniture or shelving to support & hold electronic products.

2) Designed to hold any electronic product so that it can easily be connected to the TV or computer.

3) Securely mounts to any TV wall bracket or wall behind the TV or to any piece of furniture.

4) Eliminates the need to run wires.

5) All wires remain concealed.

6) Does no visible wall damage.

7) Relatively inexpensive.

8) Convenient and easy to use.

9) Electronics products are more securely mounted compared to shelving.

10) Saves space so there is less clutter.

A latitude of modification, change and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

What is claimed is:

1. A universal holder and flexible member for mounting, holding, and adjustably positioning electronic products and accessories relative to a TV, computer, or furniture, comprising:
a) a mounting lug(s) for screwing or bolting it to a TV wall bracket or the wall behind the TV or computer screen or to furniture;
b) a flexible member or gooseneck for connecting to one end of said mounting lug;
c) a holding device having adjustable gripping arms or any other means of securing electronic products, for receiving any electronic product that can be wired to and connected to a TV, wherein said holding device is removably connected to the other end of said flexible gooseneck member; and
d) said flexible member or gooseneck and said holding device for holding the electronic products and accessories are movable as one unit to different positions relative to a TV or computer, and around the periphery of the TV or computer for easy access of the electronic product and accessory by the user.

2. A flexible connector in accordance with claim 1, wherein said electronic component or accessory includes a cable box, a satellite receiver, an iPod and other media playing devices, a DVD, Blueray, VCR and all other stereo components; gaming consoles, such as Xbox, Playstation and Wii; laptop computers, cell phones, Blackberry units, digital cameras, and all other such electronic accessories or components.

3. A universal flexible connector or gooseneck, and a movable holding device for adjustably positioning one or more electronic devices, such as any media playing device, relative to a TV or furniture, comprising:
a) means for mounting on a TV wall bracket or on a wall behind the TV or computer screen;
b) a flexible connector for connecting to said mounting means;
c) a holding device having adjustable gripping arms for receiving any electronic component or accessory or media playing device (MPD), wherein said holding device is removably connected to the other end of said flexible connector; and
d) said flexible connector and said holding device for holding the electronic component or accessory or the media playing device (MPD) and for moving them as a unit to different positions relative to a TV, outside the periphery of the TV, for access to the media playing device (MPD) or other electronic component or accessory by the user.
